(19) United States
(12) Patent Application Publication
(10) Pub. No.: US 2021/0206106 A1
(43) Pub. Date: Jul. 8, 2021

(54) DETERMINING AMOUNTS OF PRINT MATERIALS CONSUMED

(71) Applicant: HEWLETT-PACKARD DEVELOPMENT COMPANY, L.P., Spring, TX (US)

(72) Inventors: Jordi GONZALEZ ROGEL, Sant Cugat del Valles (ES); Sergio GONZALEZ, Sant Cugat del Valles (ES); Yngvar ROSSOW SETHNE, Sant Cugat del Valles (ES); Sebastia CORTES i HERMS, Sant Cugat del Valles (ES); Sergio PUIGARDEU ARAMENDIA, Sant Cugat del Valles (US); Alex CARRUESCO LLORENS, Sant Cugat del Valles (ES)

(73) Assignee: HEWLETT-PACKARD DEVELOPMENT COMPANY, L.P., Houston, TX (US)

(21) Appl. No.: 16/087,681

(22) PCT Filed: Apr. 20, 2017
(86) PCT No.: PCT/US2017/028527

§ 371 Date: Sep. 24, 2018

(51) Int. Cl. B29C 64/386; B29C 64/321; B33Y 10/00; B33Y 30/00; B33Y 50/00

(52) U.S. Cl. CPC B29C 64/386; B29C 64/321; B29C 64/106; B33Y 30/00; B33Y 50/00; B33Y 10/00

(57) ABSTRACT

A method comprises determining an amount of print materials consumed in at least part of a build job comprising a plurality of objects, and distributing the amount of print materials consumed on an object by object basis to the plurality of objects forming the build job.

### BACKGROUND

Three-dimensional objects generated by an additive manufacturing process may be formed in a layer-by-layer manner. In one example of additive manufacturing, an object is generated by solidifying portions of layers of build material. In examples, the build material may be in the form of a powder, liquid or sheet material. The intended solidification and/or physical properties may be achieved by printing an agent onto a layer of the build material. Energy may be applied to the layer and the build material on which an agent has been applied may coalesce and solidify upon cooling. In other examples, chemical binding agents may be used to solidify a build material. In other examples, three-dimensional objects may be generated by using extruded plastics or sprayed materials as build materials, which solidify to form an object.

Some printing processes that generate three-dimensional objects use data generated from a model of a three-dimensional object. This data may, for example, specify the locations at which to apply an agent to the build material, or where a build material itself may be placed, and the amounts to be placed. The data may be generated from a 3D representation of an object to be printed.

During a particular printing process or build job, a plurality of three dimensional objects may be printed within a fabrication chamber or build volume of a printer apparatus.

### BRIEF DESCRIPTION OF DRAWINGS

Examples will now be described, by way of non-limiting example, with reference to the accompanying drawings, in which:

FIG. 1 shows an example of objects forming part of a build job;

FIG. 2 is a flowchart of an example of a method of distributing print materials consumed on an object by object basis;

FIG. 3 is an example of part of a build job comprising a plurality of objects;

FIG. 4 is an example of an additive manufacturing apparatus; and

FIG. 5 is an example of a machine readable medium.

### DETAILED DESCRIPTION

Additive manufacturing techniques may generate a three-dimensional object through the solidification of a build material. The build material may be powder-based and the properties of generated objects may depend on the type of build material and the type of solidification mechanism used. In a number of examples of such techniques including sintering techniques, build material is supplied in a layer-wise manner and the solidification method includes heating the layers of build material to cause melting in selected regions. In other techniques, chemical solidification methods may be used.

Additive manufacturing systems may generate objects based on structural design date. This may involve a designer generating a three-dimensional model of an object to be generated, for example using a computer aided design (CAD) application. The model may define the solid portions of the object. To generate a three-dimensional object from the model using an additive manufacturing system, the model data can be processed to generate slices of parallel planes of the model. Each slice may define a portion of a respective layer of build material that is to be solidified or caused to coalesce by the additive manufacturing system. Such data may be referred to as object model data.

In some examples, at least one print agent may be selectively applied to the build material, and may be liquid when applied. For example, a fusing agent (also termed a “coalescence agent” or “coalescing agent”) may be selectively distributed onto portions of a layer of build material in a pattern derived from data representing a slice of a three-dimensional object to be generated (which may for example be generated from structural design data or object model data). The fusing agent may have a composition which absorbs energy such that, when energy (for example, heat) is applied to the layer, the build material coalesces and solidifies to form a slice of the three-dimensional object in accordance with the pattern. In other examples, coalescence may be achieved in some other manner. In some examples, a detailing agent may also be used (also termed a “coalescence modifier agent” or “coalescing modifier agent”), wherein the detailing agent is used for example near edge surfaces of an object being printed, or areas requiring more accurate detailing.

During a particular printing process or build job, a plurality of three dimensional objects or parts may be printed within a fabrication chamber or build volume of a printer apparatus.

Thus, a build job on an additive manufacturing apparatus may comprise one object or a plurality of objects laid together within a build volume of the additive manufacturing apparatus, i.e. within the 3D bed space.

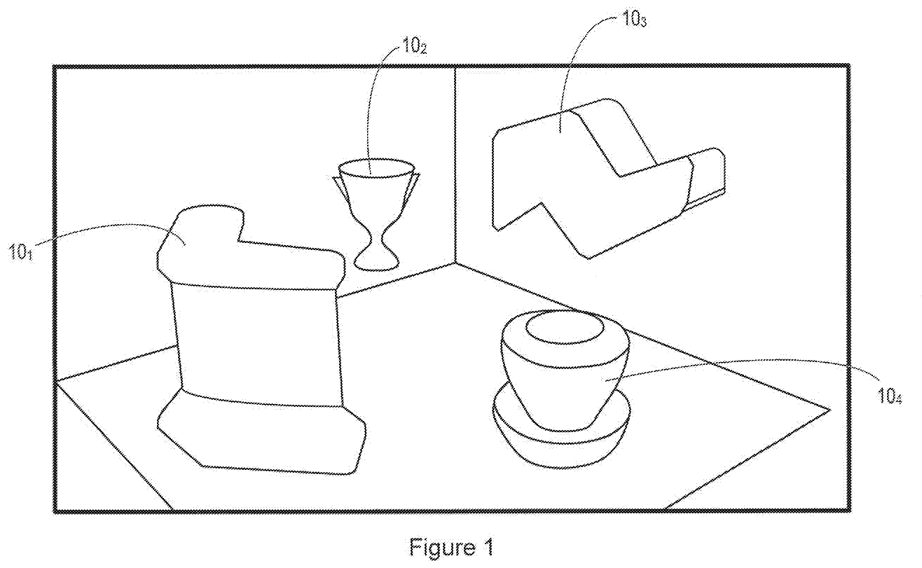

FIG. 1 shows an example of a build job which comprises four objects to be built, illustrated as objects 10₁ to 10₄, positioned together in a 3D bed space, also referred to herein as a build volume. Object model data may be received by a printer for printing the plurality of objects 10₁ to 10₄, which describes the content of the build job, by defining the objects to be built, and where the objects are to be placed in the build volume.

In an example where 3D build jobs are printed layer by layer, each layer may comprise a combined raster image for all the objects involved in that layer.

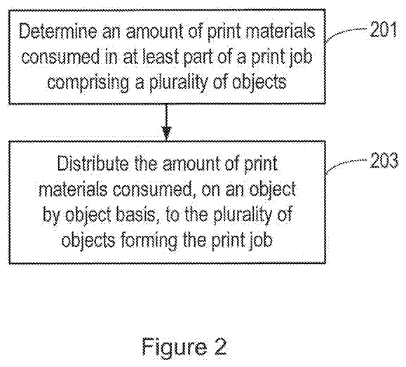

FIG. 2 shows an example of a method of 3D printing, the method being performed for example in an additive manufacturing apparatus or three dimensional printer. In block 201 the method comprises determining an amount of print materials consumed in at least part of a build job comprising a plurality of objects. Print materials may comprise, for example, any combination of build material, print agents or other materials used during a print job. The method may comprise, for example, determining the total amount of print materials used in a complete build job. In some examples, the total amount of print materials used in a complete build job includes any print materials or supplies used in any servicing operations performed during the build job, or any print materials wasted during the built job.

In block 203 the method comprises distributing the amount of print materials consumed, on an object by object basis, to the plurality of objects forming the build job. Distributing the amount of print materials may comprise attributing or allocating the amount of print materials used in a build job against individual objects, on an object by object basis, according to the amount of print materials an individual object has contributed to the print materials consumed in the overall build job.

In one example, distributing to an object the amount of print materials consumed by that object comprises determining the volume of the object in proportion to the overall volume of the plurality of objects forming the build job. The determined proportion is used to distribute a corresponding proportion of the amount of print materials consumed to the object. In other words, such an example comprises distributing the total amount of print materials consumed against the individual objects forming part of the build job, in relative proportion to the volume of each object compared to the overall volume of the objects in totality.

In one example where the print materials comprise build material, the amount of build material consumed for the build job is distributed proportionally to each object according to the volume of each object with respect to the combined volume of the plurality of objects.

In some examples, the volume of an object may be determined by determining the number of voxels of build material that form an object. For example, the method may comprise determining the number of solid voxels that form an object, wherein a solid voxel is a three dimensional volumetric unit of build material which can be fused by a fusing agent. In some examples, the number of voxels of build material forming an object may include empty voxels which are encapsulated by solid voxels and which cause unfused build material to be trapped inside a printed object.

In another example where the print materials comprise build material, and wherein the build material comprises an aggregate of the actual build material used to form the plurality of objects and the waste build material consumed or generated during the forming of the objects (for example build material that cannot be recycled), then the amount of actual build material consumed is distributed to an object based on the proportionality of the volume of the object in relation to the overall volume of the plurality of objects, and wherein the amount of waste build material that has been consumed is distributed to an object based on the surface of the object in relation to the overall surface of the plurality of objects. In some examples, the volume of an object can be determined as mentioned above, according to the number of voxels, or solid voxels, forming the object. In some examples, the surface of an object may be determined by determining the number of solid voxels of an object that are in contact with non-fused build material (wherein a solid voxel is a voxel that has been fused). As such, in some examples the surface of an object relates to the volume of voxels belonging to the 3D surface of that object, i.e. corresponding to the volume of solid voxels in contact with non-fused material.

In an example where the print materials comprise recycled build material, the amount of recycled build material consumed is distributed to an object based on the proportionality of the volume of the object in relation to the overall volume of the plurality of objects. In examples described herein, references to recycled build material may relate, for example, to the amount of build material used for printing that can be recycled. As above, in some examples the volume of an object can be determined according to the number of voxels, or solid voxels and/or empty voxels forming the object.

In an example where the print materials comprise fusing agent, the fusing agent consumed is distributed to an object based on the proportionality of the volume of the object in relation to the overall volume of the plurality of objects. In some examples, the amount of fusing agent forming the print materials of a build job may comprise at least some form of overhead, for example corresponding to an amount of fusing agent consumed for servicing purposes, for example on each layer, and for the overall build job. As above, in some examples the volume of an object may be determined according to the number of voxels of build material that form an object. For example, the method may comprise determining the number of solid voxels and/or empty voxels that form an object.

In an example where the print materials comprise detailing agent, the amount of detailing agent consumed is distributed to an object based on the proportionality of the surface of the object in relation to the overall surface of the plurality of objects. In some examples, the amount of detailing agent forming the print materials of a build job may comprise at least some form of overhead, for example corresponding to an amount of detailing agent consumed for servicing purposes, for example on each layer, and for the overall build job. In some examples, the surface of an object may be determined by determining the number of solid voxels of an object that are in contact with non-fused build material (wherein a solid voxel is a voxel that has been fused). In some examples the amount of detailing agent consumed may include detailing agent used in internal structures, for example detailing agent used as a cooling agent on internal structures or surfaces. In such examples the amount of detailing agent consumed for such purposes may be determined on-the-fly, for example based on thermal feedback systems.

The amount of print agent, e.g. fusing agent and/or detailing agent, consumed may be determined, for example, by counting in hardware how many drops of print agent are actually fired, for example to determine how many solid voxels form part of an object, or how many solid voxels are in contact with non-fused build material. Other methods may also be used for determining the amount of print agent consumed, and/or the volume or surface of an object.

Thus, the examples described above determine the consumption of print materials (or supplies) used to build the plurality of individual objects, whereby the total consumption of supplies relating to the build job is distributed to individual objects within the total build job.

In one example, determining the amount of print materials consumed, and distributing the amount of print materials consumed on an object by object basis, are performed on a layer by layer basis of the build job. In such an example the method tracks consumption of print materials, on a layer by layer basis, and distributes the consumption of print materials to individual objects in an incremental manner as the build job is progressing. In such an example, the method may comprise incrementally determining the volume and/or surface of each object, while printing, based on determining a layer volume and/or layer surface of each object, which are used to increment the cumulative totals of volume and/or surface for each object.

For example, the method may comprise determining incremental values of object volume and object surface, on a layer by layer basis as a build job is progressing, and distributing the amount of print materials used to each object, based on the determined incremental values of object volume and object surface. For example, as a build job progresses, the total amount of print materials used to that point are distributed to any objects which have been built to that point, either part-built or fully built, according to the volume of each such object, and/or according to the surface of each object to the extent that they have been built to that point of the build process. It is noted that the surface of a part-built object relates to the surface that would form a surface of the final object, e.g. an outer surface of the final object, and as such does not necessarily include the exposed surface corresponding to the cross section through that object at that particular layer of processing the part built object. In some examples, the surface may be determined by counting the number of solid voxels (e.g. fused voxels) of build material of an object that are in contact with non-fused voxels of build material.

In some examples, determining the print materials consumed may comprise determining a layer volume for each object being printed in that layer. The layer volume may comprise the number of solid voxels in that layer, for each of the objects in that layer.

In some examples, determining the print materials consumed may comprise determining a 3D layer surface for each object being printed in that layer. The 3D layer surface may comprise the number of solid voxels in that layer that are in contact with non-fused build material, for each of the objects in that layer. This may include not just solid voxels around the perimeter of an object in that layer that are in contact with non-fused build material in that layer, but also any solid voxels which are in contact with non-fused build material in a previous layer or a next layer, for example where a particular layer defines a top portion or bottom portion on an object, or some small surface that arises due to a previous or next layer not printing on those voxels.

Thus, while printing, the method tracks the print materials consumed on an incremental basis, and distributes the amount of print materials consumed accordingly to each respective object. When a build job ends, the method provides, for an individual object, the print materials consumed to build that object.

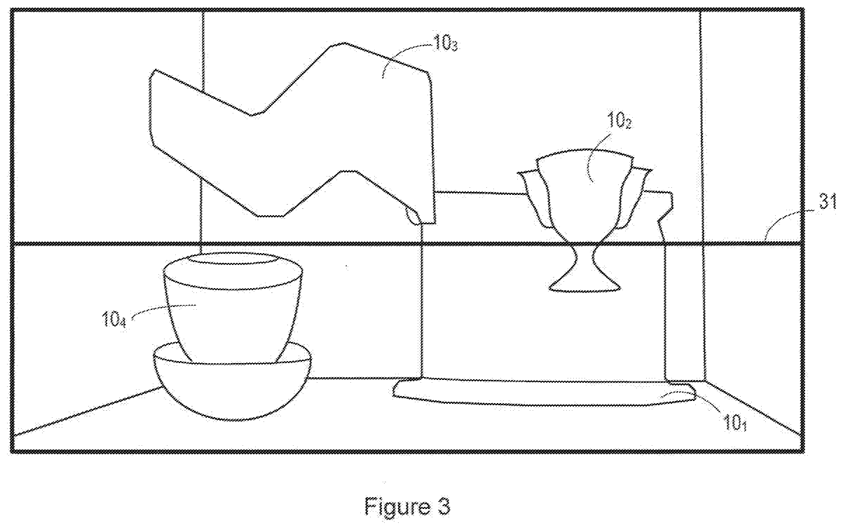

Referring to FIG. 3, in an example where the volume of each object and the surface of each object is incrementally determined on a layer by layer basis during a build job, if at any time the build job becomes interrupted (for example has failed or been cancelled), for example at the point indicated by the line 31, the print materials consumed so far for each object may still be determined. This includes both finished objects and unfinished objects at that stage of the build job. The build job information accumulated so far, for example by determining layer volume and layer surface as mentioned above, may be restored at printer reboot, including the accumulated consumption of print materials, and how these have been distributed or attributed to individual objects.

In the example of FIG. 3, the method will know the volume and surface of the object 10₄ which has finished being built, the part volume and part surface of the object 10₁ which is part built, and the part volume and part surface of the object 10₂, which is also part built.

Using the examples described earlier, the amount of build material consumed to that point 31 in the build job may therefore be distributed to object 10₄ based on the volume of fully built object 10₄ in proportion to the combined volume of the object 10₄ plus the volume of part built object 10₁ plus the volume of part built object 10₂. Likewise, the amount of build material consumed to that point 31 in the build job may be distributed to part built object 10₁ based on the volume of part built object 10₁ (i.e. its volume to that point) in proportion to the combined volume of the object 10₄ plus the volume of part built object 10₁ plus the volume of part built object 10₂. Likewise, the amount of build material consumed to that point 31 in the build job may be distributed to part built object 10₂ based on the volume of part built object 10₂ (i.e. its volume to that point) in proportion to the combined volume of the object 10₄ plus the volume of part built object 10₁ plus the volume of part built object 10₂.

In an example where the print materials comprise waste build material, the amount of waste build material consumed to that point 31 in the build job may therefore be distributed to object 10₄ based on the surface of fully built object 10₄ in proportion to the combined surface of the object 10₄ plus the surface of part built object 10₁ plus the surface of part built object 10₂. Likewise, the amount of waste build material may be distributed to part built objects 10₁ and 10₂ in a similar way, according to the respective surfaces of those objects in proportion to the total surfaces of the objects 10₄, 10₁ and 10₂ to that point of the build job.

In an example where the print materials comprise fusing agent, the amount of fusing agent consumed to that point 31 in the build job may therefore be distributed to object 10₄ based on the volume of the fully built object 10₄ in proportion to the combined volumes of the object 10₄ plus the volume of part built object 10₁ plus the volume of part built object 10₂. Likewise, the amount of fusing agent may be distributed to part built objects 10₁ and 10₂ in a similar way, according to the relative volumes of those objects in proportion to the total volumes of the objects 10₄, 10₁ and 10₂ to that point of the build job.

In an example where the print materials comprise detailing agent, the amount of detailing agent consumed to that point 31 in the build job may therefore be distributed to object 10₄ based on the surface of fully built object 10₄ in proportion to the combined surface of the object 10₄ plus the surface of part built object 10₁ plus the surface of part built object 10₂. Likewise, the amount of detailing agent may be distributed to part built objects 10₁ and 10₂ in a similar way, according to the relative surfaces of those objects in proportion to the total surfaces of the objects 10₄, 10₁ and 10₂ to that point of the build job. As mentioned above, it is noted that the surface of part-built objects 10₁ and 10₂ relates to the surfaces of those objects that would form a surface, e.g. an outer surface, of the final objects, and as such does not include the exposed surface corresponding to the cross section through that object at that layer of processing the part built object.

From the above examples, while printing, a printer tracks the consumption of print materials and distributes the consumption of print materials accordingly to each respective object. Men the build job ends, the printer has, for each individual object, the supplies consumed to build each object. Such information may be used, for example, to determine individual costs of manufacturing a particular object, which can then be used, for example, to charge accordingly. In other examples the information may be used to make a comparison between printed objects, for example to determine whether two objects have a similar amount of print materials used, for example for use in part quality assessment. In other examples the information may be used in systems where it is not otherwise possible to determine what print materials have been used to print an object. Furthermore, in an example where print materials are distributed to objects on a layer by layer basis, then if at any time the job gets interrupted (e.g. either failed or cancelled), the print materials consumed so far for each object are reported. This includes both finished and unfinished parts.

The examples described above may distribute print material consumption during or after a build job. In another example, the print materials can be distributed to objects prior to a build job, for example to estimate the print materials that will be consumed to build each object, in proportion to the volume and/or surface of each object, in a similar manner to that described above. Such estimation may be based, for example, on object model data, either for a whole object, or for a layer by layer of an object, prior to a printing process being performed.

In some examples, the amount of build material consumed may include at least one compensation factor, which may depend or be related, for example, to the print materials, or print mode or temperature used in a build job. For example, the at least one compensation factor may be provided to compensate for any contractions or shrinkage that might occur during the build job. Such a compensation factor may therefore take into account that some material is wasted around the objects, and should therefore be included as consumed print material. The amount of material wasted around objects may be based, for example, on predetermined information, or on some experimental heuristics, and may correspond, for example, in the order of a few millimetres of waste thickness. Such a compensation factor may therefore be taken into consideration in any of the examples described above, when distributing the consumed print materials to individual objects.

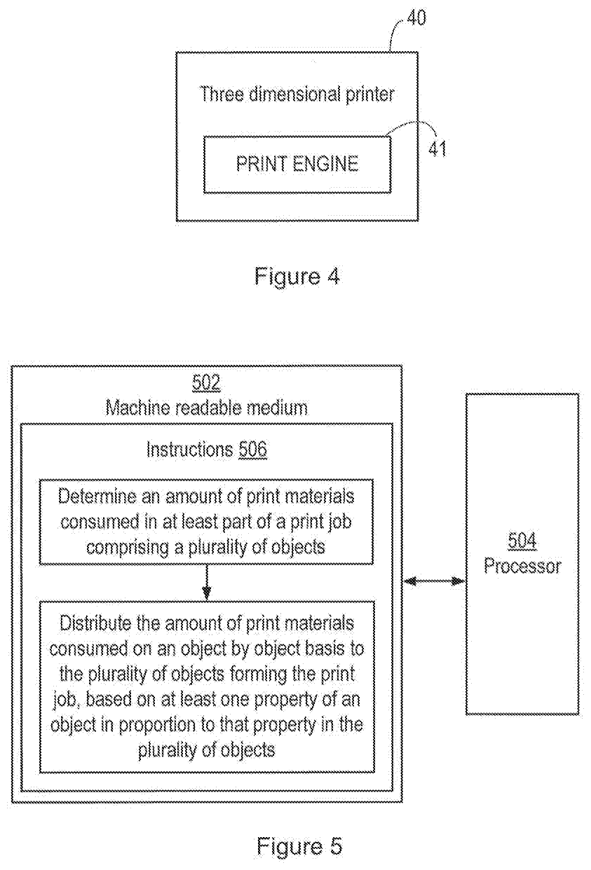

FIG. 4 shows an example of an additive manufacturing apparatus 40, for example a three dimensional printer. The additive manufacturing apparatus 40 comprises a print engine 41 to determine an amount of print materials consumed in at least part of a build job comprising a plurality of objects. The print engine 41 proportionally distributes the amount of print materials used, to each object of the plurality of objects, based on the respective volume and/or outer surface of each object compared to the overall volume and/or overall outer surface of the plurality of objects.

In one example, when each layer is printed, the print engine 41 provides the amount of print material consumed for that layer, and distributes the consumption of print materials to each object, on a layer by layer basis. That information may be accumulated for the whole build job, such that once the build job is completed, the amount of print material consumed is split among the different objects that have been built, for example based on the following.

In one example the consumed build material takes into consideration the amount due to the volume of the object and the surface of the object. The surface of an object, plus a waste thickness value, provide an amount of waste build material consumed. This may also be used to provide the relative proportions of the build material in the objects, and the waste build material that is wasted around the objects. The build material in the objects may be split proportionally by the print engine 41 to the relative volumes of the objects, and the waste build material may be split proportionally by the print engine 41 to the relative surfaces of the objects. The overall consumption of the build material is an aggregate of these two values.

In some examples, the volume of an object may be determined by determining the number of voxels of build material that form an object. For example, the method may comprise determining the number of solid voxels that form an object, wherein a solid voxel is a three dimensional volumetric unit of build material which can be fused by a fusing agent. The volume may be incremented on a layer by layer basis, by determining the volume of each object, while printing, based on a layer volume of each object. Each layer volume per object is used to increment the cumulative total volume for each object.

In an example, the print engine splits the overall recycled build material among the objects proportionally to their respective volumes. The respective volumes may be determined as mentioned above.

In an example, the print engine 41 splits the fusing agent consumption among the objects proportionally to their respective volumes. The respective volumes may be determined as mentioned above.

In an example, the print engine 41 splits the detailing agent consumption among the objects proportionally to their respective surfaces. In some examples, the surface may be determined by counting the number of solid voxels (e.g. fused voxels) of build material of an object that are in contact with non-fused voxels of build material. In an example which determines the print materials consumed on a layer by layer basis, the print engine 41 may determine a 3D layer surface for each object being printed in that layer. The 3D layer surface may comprise the number of solid voxels in that layer that are in contact with non-fused build material, for each of the objects in that layer. This may include not just solid voxels around the perimeter of an object in that layer that are in contact with non-fused build material in that layer, but also any voxels which are in contact with non-fused build material in the previous layer or the next layer, for example where a particular layer defines a top portion or bottom portion on an object, or some small surface that arises due to a previous or next layer not printing on those voxels.

In examples described herein, tracking the incremental volume and/or incremental surface, based on a layer volume and layer surface as mentioned above, may comprise, for example, using the raster image of an object in that layer, and adding them all together.

For example, tracking the incremental surface printed for a layer may be determined when generating the raster image of objects in the layer, for example by counting the voxels that belong to the 3D surface of any object, and then adding them all for that layer.

The examples described herein provide a robust method of determining the amount of print materials consumed for individual objects, as well as, for example, an entire build job. Examples which accumulate this information on a layer by layer basis can distribute the amount of print materials consumed so far by individual objects, thus dealing with printer crashes or power cuts. The accumulated information can be used during a subsequent power-up of the printer.

FIG. 5 shows an example of a machine readable medium 502 storing instructions which, when executed by a processor 504 cause the processor 504 to: determine an amount of print materials consumed in at least part of a print job comprising a plurality of objects; and distribute the amount of print materials consumed on an object by object basis to the plurality of objects forming the print job, based on at least one property of an object in proportion to that property in the plurality of objects. In some examples the at least one property may comprise a volume and/or surface of an object.

Examples in the present disclosure can be provided as methods, systems or machine readable instructions, such as any combination of software, hardware, firmware or the like. Such machine readable instructions may be included on a computer readable storage medium (including but is not limited to disc storage, CD-ROM, optical storage, etc.) having computer readable program codes therein or thereon.

The present disclosure is described with reference to flow charts and/or block diagrams of the method, devices and systems according to examples of the present disclosure. Although the flow diagrams described above show a specific order of execution, the order of execution may differ from that which is depicted. Blocks described in relation to one flow chart may be combined with those of another flow chart. It shall be understood that each flow and/or block in the flow charts and/or block diagrams, as well as combinations of the flows and/or diagrams in the flow charts and/or block diagrams can be realized by machine readable instructions.

The machine readable instructions may, for example, be executed by a general purpose computer, a special purpose computer, an embedded processor or processors of other programmable data processing devices to realize the functions described in the description and diagrams. In particular, a processor or processing apparatus may execute the machine readable instructions. Thus functional modules of the apparatus and devices may be implemented by a processor executing machine readable instructions stored in a memory, or a processor operating in accordance with instructions embedded in logic circuitry. The term ‘processor’ is to be interpreted broadly to include a CPU, processing unit, ASIC, logic unit, or programmable gate array etc. The methods and functional modules may all be performed by a single processor or divided amongst several processors.

Such machine readable instructions may also be stored in a computer readable storage that can guide the computer or other programmable data processing devices to operate in a specific mode.

Such machine readable instructions may also be loaded onto a computer or other programmable data processing devices, so that the computer or other programmable data processing devices perform a series of operations to produce computer-implemented processing, thus the instructions executed on the computer or other programmable devices realize functions specified by flow(s) in the flow charts and/or block(s) in the block diagrams.

Further, the teachings herein may be implemented in the form of a computer software product, the computer software product being stored in a storage medium and comprising a plurality of instructions for making a computer device implement the methods recited in the examples of the present disclosure.

While the method, apparatus and related aspects have been described with reference to certain examples, various modifications, changes, omissions, and substitutions can be made without departing from the spirit of the present disclosure. It is intended, therefore, that the method, apparatus and related aspects be limited only by the scope of the following claims and their equivalents. It should be noted that the above-mentioned examples illustrate rather than limit what is described herein, and that those skilled in the art will be able to design many alternative implementations without departing from the scope of the appended claims.

The word “comprising” does not exclude the presence of elements other than those listed in a claim, “a” or “an” does not exclude a plurality, and a single processor or other unit may fulfil the functions of several units recited in the claims.

The features of any dependent claim may be combined with the features of any of the independent claims or other dependent claims.

1. A method of 3D printing comprising:
determining an amount of print materials consumed in at least part of a build job comprising a plurality of objects; and
distributing the amount of print materials consumed, on an object by object basis, to the plurality of objects forming the build job.

2. A method as in claim 1, wherein distributing to an object the amount of print materials consumed by that object comprises:
determining the volume of the object in proportion to the overall volume of the plurality of objects forming the build job; and
using the determined proportion to distribute a corresponding proportion of the amount of print materials consumed to the object.

3. A method as in claim 1, wherein the print materials comprises build material, and wherein the amount of build material consumed for the build job is distributed proportionally to each object according to the volume of each object with respect to the combined volume of the plurality of objects.

4. A method as in claim 1, wherein the print materials comprises build material, the build material comprising an aggregate of actual build material consumed to form the plurality of objects, and waste build material consumed or generated in the forming of the plurality of objects, and wherein:
the amount of actual build material consumed is distributed to an object based on the proportionality of the volume of the object in relation to the overall volume of the plurality of objects; and
the amount of waste build material consumed is distributed to an object based on the surface of the object in relation to the overall surface of the plurality of objects.

5. A method as in claim 1, wherein the print materials comprise recycled build material, and wherein the amount of recycled build material consumed is distributed to an object based on the proportionality of the volume of the object in relation to the overall volume of the plurality of objects.

6. A method as in claim 1, wherein the print materials comprise fusing agent, and wherein the amount of fusing agent consumed is distributed to an object based on the proportionality of the volume of the object in relation to the overall volume of the plurality of objects.

7. A method as in claim 1, wherein the print materials comprise detailing agent, and wherein the amount of detailing agent consumed is distributed to an object based on the proportionality of the surface of the object in relation to the overall surface of the plurality of objects.

8. A method as in claim 1, wherein determining the amount of print materials consumed, and distributing the amount of print materials consumed, on an object by object basis, are performed on a layer by layer basis of the build job.

9. A method as in claim 8, comprising determining incremental values of object volume and object surface, on a layer by layer basis as a build job is progressing, and distributing the amount of print materials used to individual objects, based on the determined incremental values of object volume and object surface.

10. A method as in claim 1, wherein the amount of print materials consumed comprises print materials used in at least one servicing operation.

11. A method as in claim 1, wherein the amount of print materials consumed in a build job comprises at least one compensation factor.

12. An additive manufacturing apparatus comprising:
a print engine to determine an amount of print materials consumed in at least part of a build job comprising a plurality of objects;
wherein the print engine proportionally distributes the amount of print materials used to each object of the plurality of objects, based on the respective volume and/or surface of each object compared to the overall volume and/or overall surface of the plurality of objects.

13. An additive manufacturing apparatus as in claim 12, wherein the print materials comprises build material, the build material comprising an aggregate of actual build material consumed to form the plurality of objects, and waste build material consumed or generated in the forming of the plurality of objects, and wherein the print engine:
distributes the amount of actual build material consumed, to an object, based on the proportionality of the volume of the object in relation to the overall volume of the plurality of objects; and
distributes the amount of waste build material consumed, to an object, based on the surface of the object in relation to the overall surface of the plurality of objects.

14. An additive manufacturing apparatus as in claim 12 wherein:
the print materials comprise recycled build material, and wherein the print engine distributes the amount of recycled build material consumed, to an object, based on the proportionality of the volume of the object in relation to the overall volume of the plurality of objects; or
the print materials comprise fusing agent, and wherein the print engine distributes the amount of fusing agent consumed, to an object, based on the proportionality of the volume of the object in relation to the overall volume of the plurality of objects; or
the print materials comprise detailing agent, and wherein the print engine distributes the amount of detailing agent consumed, to an object, based on the proportionality of the surface of the object in relation to the overall surface of the plurality of objects.

15. A machine readable medium storing instructions which, when executed by a processor cause the processor to:
determine an amount of print materials consumed in at least part of a print job comprising a plurality of objects; and
distribute the amount of print materials consumed, on an object by object basis, to the plurality of objects forming the print job, based on at least one property of an object in proportion to that property in the plurality of objects.
